(19) United States
(12) Patent Application Publication
(10) Pub. No.: US 2026/0261083 A1
(43) Pub. Date: Sep. 3, 2026

(54) TEMPERATURE CONTROL PLUG

(71) Applicant: BESTWAY INFLATABLES & MATERIAL CORP., Shanghai (CN)

(72) Inventors: Xianglin ZENG, Shanghai (CN); Qingshui SONG, Shanghai (CN)

(21) Appl. No.: 19/540,955

(22) Filed: Feb. 16, 2026

(30) Foreign Application Priority Data
Feb. 28, 2025 (CN) 202520336589.6

(51) Int. Cl. H01R 13/713; H01R 24/28

(52) U.S. Cl. CPC H01R 13/7137; H01R 24/28

(57) ABSTRACT

A temperature control plug includes a housing having an accommodating cavity, a first power pin connected to a first power cord and supplies power to an external load and includes a first end and a second end, the first end of the first power pin being located in the accommodating cavity, and the second end of the first power pin extending out of the accommodating cavity, a second power pin connected to a second power cord and supplies power to the external load and includes a first end and a second end, the first end of the second power pin being located in the accommodating cavity, the second end of the second power pin extending out of the accommodating cavity, and the second power pin being spaced apart from the first power pin, a control circuit board, and a temperature-sensing element, which is arranged in the accommodating cavity and electrically connected to the control circuit board and measures a temperature of the first power pin.

The present disclosure claims priority to Chinese Patent Application No. CN202520336589.6, filed with the China National Intellectual Property Administration on Feb. 28, 2025 and entitled “TEMPERATURE CONTROL PLUG”, which is incorporated herein by reference in its entirety.

### TECHNICAL FIELD

The present disclosure relates to the technical field of electrical appliances, and in particular to a temperature control plug.

### BACKGROUND

Electrical appliances and consumer electronic devices are commonly powered through detachable electrical connectors, such as plugs, configured to be inserted into corresponding power sockets. During normal operation, electrical current flows through conductive power pins of the plug and mating contacts of the socket to supply power to an external load. Reliable electrical contact between the plug and the socket may ensure safe operation of the plug and efficient power delivery.

However, many traditional plugs are subject to excessive heating due to poor contact between the plug and power socket, which can lead to a variety of safety hazards. For example, prolonged overheating may cause deformation or melting of the plug housing, degradation of internal electrical components, damage to the socket, or, in severe cases, fire hazards. These risks are particularly pronounced in high-power appliances, continuous-duty loads, or environments where plugs remain connected for extended periods of time.

Accordingly, there is a need for an improved electrical plug capable of accurately sensing temperature conditions associated with the power pins themselves and responding promptly to abnormal temperature rise. Furthermore, a need exists for a plug that enhances electrical safety by reducing the risk of overheating caused by poor contact, while maintaining a compact structure compatible with conventional sockets and power cords.

### SUMMARY

An objective of the present disclosure is to prevent a power socket or a plug being burned out due to overheating of the plug when the plug is in poor contact with the socket. The present disclosure provides a temperature control plug, which can effectively minimize the risk of a socket or a plug being burned out due to overheating of the plug.

In order to solve the above technical problem, a temperature control plug is disclosed according to implementations of the present disclosure. The temperature control plug includes: a housing having an accommodating cavity; a first power pin, which is connected to a first power cord configured to supply power to an external load and includes a first end and a second end, the first end of the first power pin being located in the accommodating cavity, and the second end of the first power pin extending out of the accommodating cavity; a second power pin, which is connected to a second power cord configured to supply power to the external load and includes a first end and a second end, the first end of the second power pin being located in the accommodating cavity, the second end of the second power pin extending out of the accommodating cavity, and the second power pin being spaced apart from the first power pin; a control circuit board; and a temperature-sensing element, which is arranged in the accommodating cavity and electrically connected to the control circuit board and is configured to measure a temperature of the first power pin.

In some embodiments, the temperature-sensing element for measuring the temperature of the first power pin is provided inside the temperature control plug, and is electrically connected to the control circuit board, which provides support for subsequent power failure protection. For example, when the temperature of the first power pin measured by the temperature-sensing element reaches a preset temperature value during the operation of the temperature control plug, the temperature-sensing element feeds back a temperature-sensing signal to the control circuit board, and the control circuit board receives the temperature-sensing signal and then controls the circuit to be disconnected, so as to prevent the temperature control plug and a socket from being burned out due to continuous temperature rise of the first power pin and the second power pin, thereby effectively improving the safety of the temperature control plug to avoid dangers.

According to some embodiments of the present disclosure, the temperature-sensing element is arranged closer to the first power pin than the control circuit board.

In some embodiments, the temperature-sensing element is arranged on the control circuit board, resulting in poor measurement accuracy of the temperature-sensing element for the temperature of the first power pin. In the above technical solution, the temperature-sensing element is arranged closer to the first power pin than the control circuit board, so that a distance between the temperature-sensing element and the first power pin is reduced, which can effectively improve the measurement accuracy for the temperature of the first power pin.

According to some embodiments of the present disclosure, a distance between the temperature-sensing element and the first power pin is a first distance, a distance between the first power pin and the second power pin is a second distance, and a ratio of the first distance to the second distance is less than or equal to 0.3.

In the embodiments described herein, the ratio of the distance between the temperature-sensing element and the first power pin to the distance between the first power pin and the second power pin is limited to be less than or equal to 0.3, so that the temperature-sensing element is located near the first power pin, which can ensure the measurement accuracy of the temperature-sensing element for the temperature of the first power pin. Thus, when the temperature of the first power pin reaches the preset temperature value, the temperature-sensing element can feed back a temperature-sensing signal to the control circuit board in a timely manner.

According to some embodiments of the present disclosure, the temperature-sensing element is located between the first power pin and the second power pin.

According to some embodiments of the present disclosure, the first power pin is located between the temperature-sensing element and the second power pin.

According to some embodiments of the present disclosure, the temperature control plug further includes: a temperature-sensing circuit board, which is arranged in the accommodating cavity and electrically connected to the control circuit board and is located between the first power pin and the second power pin, the temperature-sensing element being arranged on the temperature-sensing circuit board.

In the embodiments described herein, the temperature-sensing circuit board is arranged between the first power pin and the second power pin, and the temperature-sensing element is arranged on the temperature-sensing circuit board, so that the temperature-sensing element is located near the first power pin, which ensures the measurement accuracy of the temperature-sensing element for the temperature of the first power pin. Thus, when the temperature of the first power pin reaches the preset temperature value, the temperature-sensing element can feed back a temperature-sensing signal to the control circuit board in a timely manner.

According to some embodiments of the present disclosure, the temperature-sensing element includes a first temperature-sensing element and a second temperature-sensing element; and the first temperature-sensing element is located between the first power pin and the second temperature-sensing element, and the second temperature-sensing element is located between the first temperature-sensing element and the second power pin.

In the embodiments described herein, the first temperature-sensing element is provided to measure the temperature of the first power pin, and the second temperature-sensing element is provided to measure the temperature of the second power pin, so that when either of the first power pin and the second power pin reaches the preset temperature value, a temperature-sensing signal can be fed back to the control circuit board to enable the control circuit board to disconnect the circuit, so as to prevent the temperature control plug and the socket from being burned out, thereby improving the safety.

According to some embodiments of the present disclosure, the temperature-sensing element is arranged in the accommodating cavity; and the temperature control plug further includes a thermally conductive terminal to which the temperature-sensing element is fixed; where the thermally conductive terminal includes a pin connection portion fixed to the first power pin. In the above technical solution, the temperature-sensing element is arranged on the thermally conductive terminal, and the thermally conductive terminal is physically connected to the first power pin, so that the temperature of the first power pin can be transferred to the temperature-sensing element via the thermally conductive terminal. In this way, the temperature-sensing element can measure the temperature of the first power pin by means of the thermally conductive terminal, thereby improving the measurement accuracy for the temperature of the first power pin.

According to some embodiments of the present disclosure, the thermally conductive terminal is made of copper or aluminum.

According to some embodiments of the present disclosure, the temperature-sensing element is fixed to the thermally conductive terminal by means of a thermally conductive insulation material.

According to some embodiments of the present disclosure, the temperature-sensing element is arranged on an inner surface of the housing, and a ratio of a distance between the temperature-sensing element and the first power pin to a distance between the second power pin and the first power pin is less than or equal to 0.3.

In the embodiments described herein, the temperature-sensing element is arranged near the first power pin, which can ensure the measurement accuracy of the temperature-sensing element for the temperature of the first power pin, so that when the temperature of the first power pin reaches a preset temperature value, the temperature-sensing element can feed back a temperature-sensing signal to the control circuit board in a timely manner, so as to prevent the power pin or a power socket from being burned out, thereby ensuring the electrical safety.

### BRIEF DESCRIPTION OF THE DRAWINGS

Other features and advantages of the present disclosure will be understood from the following embodiments described in detail herein and with reference to the accompanying drawings, in which like reference numerals represent the same or similar components.

FIG. 1 is a perspective view of a temperature control plug with a portion of a housing removed, according to one or more embodiments shown and described herein;

FIG. 2 is an enlarged view of part A of the temperature control plug of FIG. 1, according to one or more embodiments shown and described herein;

FIG. 3 is another perspective view of the temperature control plug of FIG. 1, according to one or more embodiments shown and described herein;

FIG. 4 depicts an embodiment of a positional relationship between a temperature sensing element and a first power pin of the temperature control plug of FIG. 1, according to one or more embodiments shown and described herein;

FIG. 5 depicts another embodiment of a positional relationship between a temperature sensing element and a first power pin of the temperature control plug of FIG. 1, according to one or more embodiments shown and described herein;

FIG. 6 depicts another embodiment of a positional relationship between a temperature sensing element and a first power pin of the temperature control plug of FIG. 1, according to one or more embodiments shown and described herein;

FIG. 7 depicts another embodiment of a positional relationship between a temperature sensing element and a first power pin of the temperature control plug of FIG. 1, according to one or more embodiments shown and described herein;

FIG. 8 is a perspective view of another embodiment of a temperature control plug with a portion of the housing removed, according to one or more embodiments shown and described herein;

FIG. 9 is another perspective view of the temperature control plug of FIG. 8, according to one or more embodiments shown and described herein;

FIG. 10 is a perspective view of a thermally conductive terminal of the temperature control plug of FIG. 8, according to one or more embodiments shown and described herein;

FIG. 11 is another perspective view of the temperature control plug of FIG. 8, according to one or more embodiments shown and described herein;

FIG. 12 is perspective view of another embodiment of a temperature control plug with a portion of a housing removed, according to one or more embodiments shown and described herein;

FIG. 13 is another perspective view of the temperature control plug of FIG. 12, according to one or more embodiments shown and described herein; and

FIG. 14 is another perspective view of the temperature control plug of FIG. 12, according to one or more embodiments shown and described herein.

### DETAILED DESCRIPTION

Embodiments of the present disclosure are illustrated below, and those skilled in the art may readily understand advantages and effects of the present disclosure from the content disclosed in the description. Although the description of the present disclosure will be introduced in conjunction with preferred embodiments, it does not mean that features of the present disclosure are limited to the implementations described herein. On the contrary, an objective of introducing the present disclosure in conjunction with the embodiments described herein is to encompass other options or modifications that may be extended on the basis of the claims of the present disclosure. The following description contains numerous specific details in order to provide deep understanding of the present disclosure. The present disclosure may also be implemented without these details. In addition, in order to avoid confusion of the present disclosure, some specific details will be omitted in the description. It should be noted that the embodiments and the features thereof in the present disclosure can be combined with each other without conflicts.

In the description of the embodiments, it should be noted that the orientation or position relationships indicated by the terms, such as “upper”, “lower”, “inner” and “bottom”, are based on the orientation or position relationships shown in the drawings or the orientation or position relationships in which a product of the present disclosure is customarily placed during use, and are only intended to facilitate description of the present disclosure and simplify the description, rather than indicating or implying that the device or element indicated must have a specific orientation or be configured and operated in a specific orientation, and thus cannot be construed as limiting the present disclosure.

The terms “first”, “second”, etc. are only intended to distinguish the description, and should not be construed as indicating or implying the relative importance.

In the description of the embodiments, it should also be noted that the terms “arrange”, “connect”, and “connection” should be understood in a broad sense, unless otherwise explicitly specified and limited. For example, the connection may be a fixed connection, a detachable connection, or an integral connection; or may be a mechanical connection or an electrical connection; or may be a direct connection, an indirect connection by means of an intermediate medium, or internal communication between two elements. For those of ordinary skill in the art, the specific meaning of the terms mentioned above in the embodiments should be understood in specific cases.

In the description of the present disclosure, the meaning of “a plurality of” is two or more, unless specifically defined otherwise.

In order to make the objectives, technical solutions and advantages of the present disclosure clearer, the implementation of the present disclosure is further described in detail below with reference to the drawings.

It should be noted that in the specification, like reference numerals and letters denote like items in the following drawings. Therefore, once an item is defined in one of the drawings, it may not be necessary to further define and explain the item in the subsequent drawings.

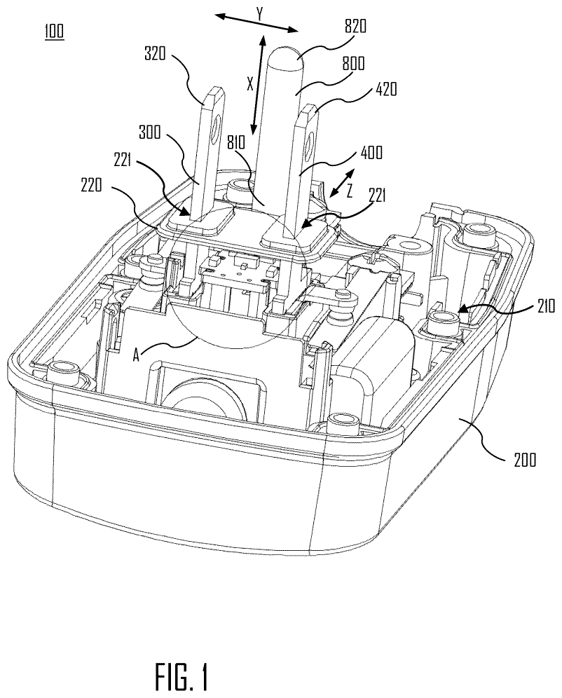

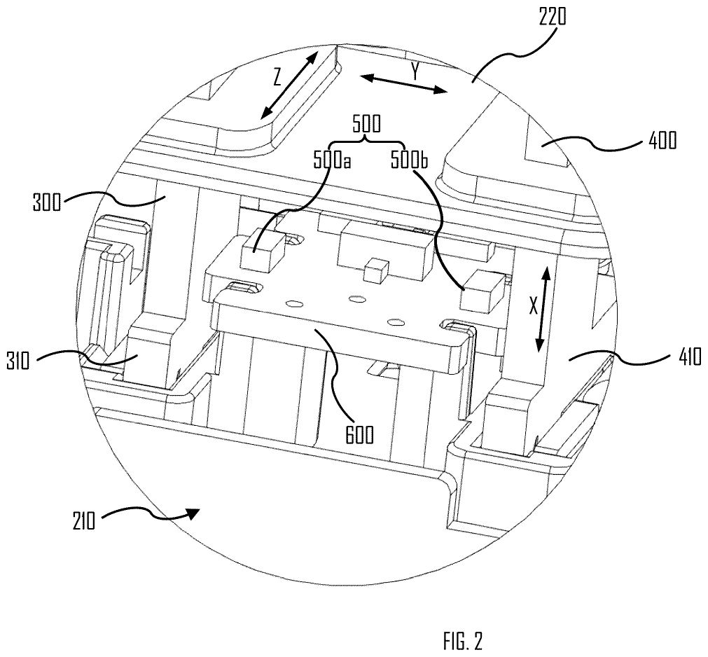

Referring now to FIGS. 1 to 3, in an embodiment, a temperature control plug 100 may include a control circuit board 110, a housing 200, a first power pin 300, a second power pin 400, a plurality of temperature-sensing elements 500 (e.g., a first temperature-sensing element 510 and the a second temperature-sensing element 520), a temperature-sensing circuit board 600, and a ground pin 800.

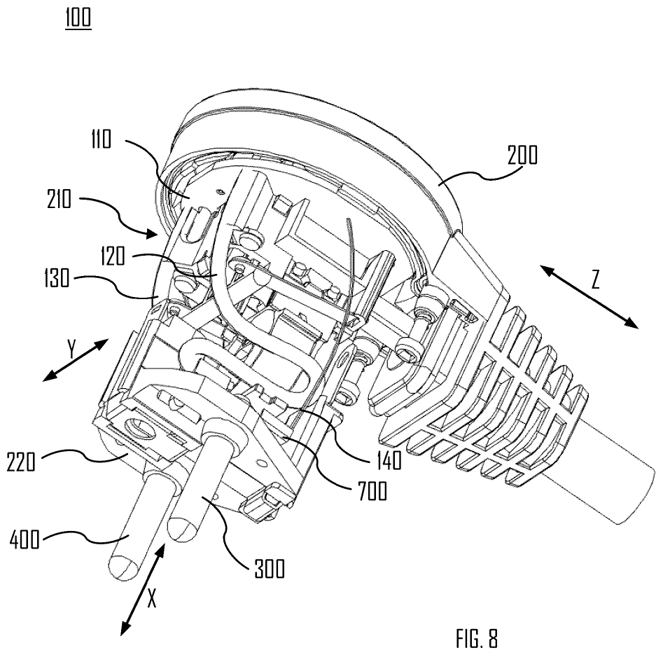

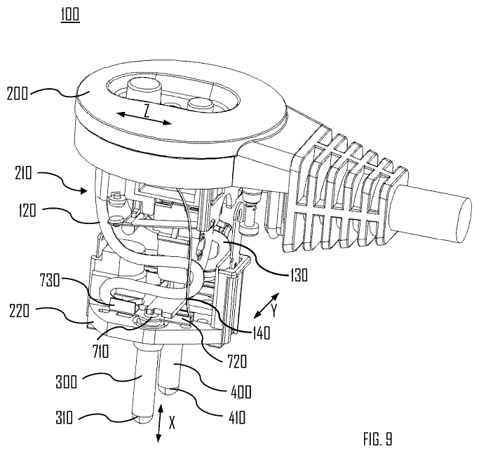

The temperature control plug 100 shown in FIG. 1 may include three pins. It should be noted that the number of pins of the temperature control plug 100 may not be specifically limited in the embodiments of the present disclosure. For example, in some other possible embodiments, the temperature control plug 100 may also be a two-pin plug (e.g., as shown in FIGS. 8 and 9). That is, the temperature control plug 100 may only include the first power pin 300 and the second power pin 400. However it should be appreciated that the temperature control plug may include any number of pins without departing from the scope of the present disclosure.

In order to describe the structure of the temperature control plug 100 in detail, an extension direction X, a spacing direction Y and a lateral direction Z are defined herein. For example, the extension direction X may be a direction in which the first power pin 300, the second power pin 400 and the ground pin 800 extend. That is, the first power pin 300, the second power pin 400 and the ground pin 800 may all extend in the extension direction X. The spacing direction Y may be a direction in which the first power pin 300 and the second power pin 400 are spaced apart. That is, the first power pin 300 and the second power pin 400 may be spaced apart in the direction Y. The lateral direction Z may be approximately perpendicular to the extension direction X and the spacing direction Y. For example, an angle between the lateral direction Z and the extension direction X may be approximately 80°, 85°, 90°, 95°, etc., an angle between the lateral direction Z and the spacing direction Y may be approximately 80°, 85°, 90°, 95°, etc., and an angle between the extension direction X and the spacing direction Y may be approximately 80°, 85°, 90°, 95°, etc.

In the embodiment of the present disclosure, the first power pin 300, the second power pin 400 and the ground pin 800 may be spaced apart from each other and are in a triangular arrangement. The ground pin 800 may be located on the same side as the first power pin 300 and the second power pin 400 in the lateral direction Z.

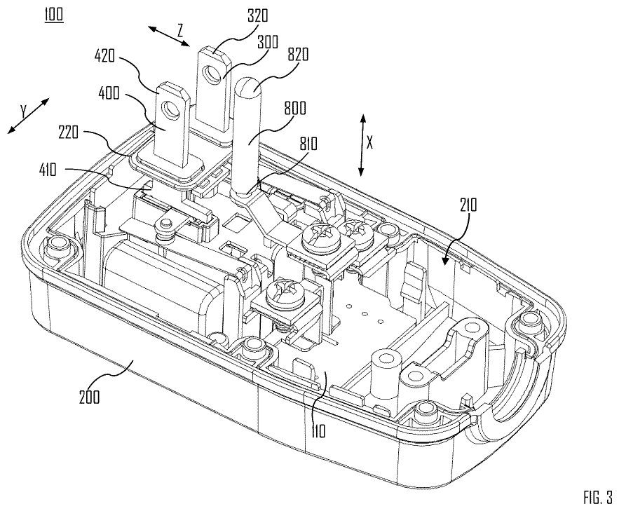

Still referring to FIGS. 1 and 3, the housing 200 may have an accommodating cavity 210, and the control circuit board 110, the temperature-sensing element 500 and the temperature-sensing circuit board 600 may be arranged in the accommodating cavity 210. It should be noted that part of the housing 200 is removed in FIGS. 1 and 3, in order to show the accommodating cavity 210 and the components located in the accommodating cavity 210.

Referring to FIG. 1, the housing 200 may further include a pin accommodation portion 220, and when the temperature control plug 100 is plugged into the socket, the pin accommodation portion 220 may face a socket. The pin accommodation portion 220 may have two through holes 221. Among the two through holes 221, one through hole 221 may be configured for the first power pin 300 to pass therethrough, and the other through hole 221 may be configured for the second power pin 400 to pass therethrough. For example, the first power pin 300 may include a first end 310 and a second end 320. The first end 310 of the first power pin 300 may be located in the accommodating cavity 210 and electrically connected to the control circuit board 110, and the second end 320 of the first power pin 300 may pass through one through hole 221 of the pin accommodation portion 220 and may extend out of the accommodating cavity 210 for connection with the socket (not shown). The second power pin 400 may include a first end 410 and a second end 420. The first end 410 of the second power pin 400 may be located in the accommodating cavity 210 and may be electrically connected to the control circuit board 110, and the second end 420 of the second power pin 400 may pass through the other through hole 221 of the pin accommodation portion 220 and may extend out of the accommodating cavity 210 for connection with the socket. The ground pin 800 may include a first end 810 and a second end 820. The first end 810 of the ground pin 800 may be located in the accommodating cavity 210 and may be connected to the control circuit board 110, and the second end 820 of the ground pin 800 may extend out of the accommodating cavity 210 for connection with the socket.

For example, the first power pin 300 may be connected to a first power cord 120 (see FIG. 8, for example) configured to supply power to an external load, the second power pin 400 may be connected to a second power cord 130 (shown in FIG. 8) configured to supply power to the external load, such that, after the temperature control plug 100 is plugged into the socket, power can be supplied to the external load (an electrical product such as a water pump or a heater) by means of the first power pin 300 and the second power pin 400. The ground pin 800 may be connected to a ground wire and configured to prevent the external load from electric leakage and hence from threatening the personal safety of a user.

For example, the first temperature-sensing element 510 and the second temperature-sensing element 520 may be arranged in the accommodating cavity 210 and electrically connected to the control circuit board 110. In particular, the temperature-sensing circuit board 600 may be arranged between the first power pin 300 and the second power pin 400, and the temperature-sensing circuit board 600 may be electrically connected to the control circuit board 110. The first temperature-sensing element 510 and the second temperature-sensing element 520 may be arranged on the temperature-sensing circuit board 600. The first temperature-sensing element 510 and the second temperature-sensing element 520 may be connected to the control circuit board 110 by means of the temperature-sensing circuit board 600. The first temperature-sensing element 510 may be configured to measure a temperature of the first power pin 300, and the second temperature-sensing element 520 may be configured to measure a temperature of the second power pin 400. The first temperature-sensing element 510 and the second temperature-sensing element 520 arranged on the temperature-sensing circuit board 600 may both be surface mount devices (e.g., surface mount thermistors), which may be small in size and low in power consumption. Some other electronic devices may also be distributed on the temperature-sensing circuit board 600 to make full use of the space of the temperature-sensing circuit board 600, so that the size of the control circuit board 110 may be reduced. The size of the temperature-sensing circuit board 600 may be smaller than that of the control circuit board 110, so that in the limited space of the accommodating cavity 210, the temperature-sensing circuit board may be more easily arranged near the first power pin 300/the second power pin 400 than the control circuit board 110. Accordingly, the first temperature-sensing element 510/the second temperature-sensing element 520 may be arranged very close to the first power pin 300/the second power pin 400, so that the control circuit board 110 can accurately sense, by means of the first temperature-sensing element 510/the second temperature-sensing element 520, whether the first power pin 300/the second power pin 400 reaches a preset temperature value. The control circuit board 110 may be provided with a circuit breaker (not shown). Once the first power pin 300 and/or the second power pin 400 reaches the preset temperature value, the circuit breaker can disconnect the circuit in the temperature control plug 100, so that the first power pin 300 and the second power pin 400 stop supplying power to the external load, so as to prevent further temperature rise of the first power pin 300/the second power pin 400.

In the spacing direction Y, the first temperature-sensing element 510 and the second temperature-sensing element 520 may be respectively arranged at opposite ends of the temperature-sensing circuit board 600. In particular, in the spacing direction Y, the first temperature-sensing element 510 may be located between the first power pin 300 and the second temperature-sensing element 520, and the second temperature-sensing element 520 may be located between the first temperature-sensing element 510 and the second power pin 400. The first temperature-sensing element 510 may be located near the first power pin 300 to improve the measurement accuracy of the first temperature-sensing element 510 for the temperature of the first power pin 300, and the second temperature-sensing element 520 may be located near the second power pin 400 to improve the measurement accuracy of the second temperature-sensing element 520 for the temperature of the second power pin 400.

During the operation of the temperature control plug 100, when the temperature of the first power pin 300 measured by the first temperature-sensing element 510 reaches a preset (e.g., predefined) temperature value (e.g., 80° C. or above) or when the temperature of the second power pin 400 measured by the second temperature-sensing element 520 reaches a preset temperature value (e.g., 80° C. or above), the temperature-sensing circuit board 600 may feed back a temperature-sensing signal to the control circuit board 110, and the control circuit board 110 may receive the temperature-sensing signal and then control the circuit to be disconnected, so as to prevent the temperature control plug 100 and the socket from being burned out due to continuous temperature rise of the first power pin 300 and the second power pin 400 to avoid dangers.

In some other embodiments, the temperature-sensing circuit board 600 and the control circuit board 110 may be one circuit board. That is, the control circuit board 110 may be arranged between the first power pin 300 and the second power pin 400 in the spacing direction Y, and the first temperature-sensing element 510 and the second temperature-sensing element 520 may both be arranged on the control circuit board 110.

It should be noted that the preset temperature value may not be specifically limited in the embodiments of the present disclosure, and can be adaptively adjusted according to actual needs (e.g., according to the national standards and the power of the load). For example, the preset temperature value may be set to 85° C., 90° C., 95° C., or any other temperature without departing from the scope of the present disclosure

Furthermore, the specific type of the temperature-sensing element 500 may not be specifically limited in the embodiments of the present disclosure. For example, the temperature-sensing element 500 may be a thermistor, a thermocouple, an infrared temperature sensor, or any other similar sensor that can effectively measure the temperature of the first power pin 300 or of the second power pin 400 without departing from the scope of the present disclosure

Similarly, the number of the temperature-sensing elements 500 may not be specifically limited in the embodiments of the present disclosure. For example, in some possible embodiments, only one temperature-sensing element 500 (e.g., the first temperature-sensing element 500) may be provided. For example, in some other embodiments, a plurality of temperature-sensing elements, such as three, four or five temperature-sensing elements 500 may also be provided to improve the measurement accuracy for the temperature of the first power pin 300 or of the second power pin 400.

In the embodiments described herein, the first temperature-sensing element 510 may be arranged closer to the first power pin 300 than the control circuit board 110. That is, the distance between the first temperature-sensing element 510 and the first power pin 300 may be shorter, which can effectively improve the measurement accuracy of the temperature-sensing element 500.

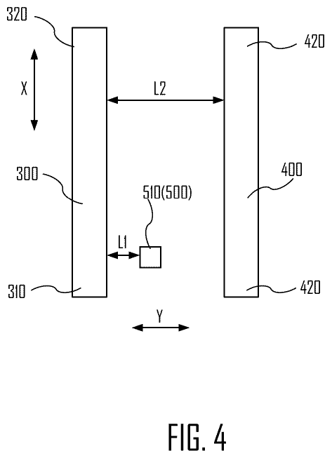

Turning now to FIGS. 4 to 7, the distance between the first temperature-sensing element 510 and the first power pin 300 may be a first distance L1, and the distance between the second temperature-sensing element 520 and the second power pin 400 may also be the first distance L1. In the spacing direction Y, the distance between the first power pin 300 and the second power pin 400 may be a second distance L2. For example, a ratio of the first distance L1 to the second distance L2 may be less than or equal to 0.3 (e.g., the ratio of the first distance L1 to the second distance L2 may also be 0.28, 0.25, 0.20, 0.1, etc.). This ratio can effectively ensure the measurement accuracy of the first temperature-sensing element 510 for the temperature of the first power pin 300 and the measurement accuracy of the second temperature-sensing element 520 for the temperature of the second power pin 400, so that the first temperature-sensing element 510 can feed back a temperature-sensing signal to the control circuit board 110 in a timely manner when the temperature of the first power pin 300 reaches the preset temperature value, and the second temperature-sensing element 520 can feed back the temperature-sensing signal to the control circuit board 110 in a timely manner when the temperature of the second power pin 400 reaches the preset temperature value.

It should be noted that the first distance L1 may refer to the shortest distance between the first temperature-sensing element 510 and any point on the first power pin 300, or the shortest distance between the second temperature-sensing element 520 and any point on the second power pin 400.

It should be noted that the positional relationship between the first temperature-sensing element 500 and the first power pin 300 and the positional relationship between the second temperature-sensing element 500 and the second power pin 400 may not be specifically limited in the embodiments of the present disclosure, as long as the ratio of the first distance L1 to the second distance L2 may be less than or equal to 0.3.

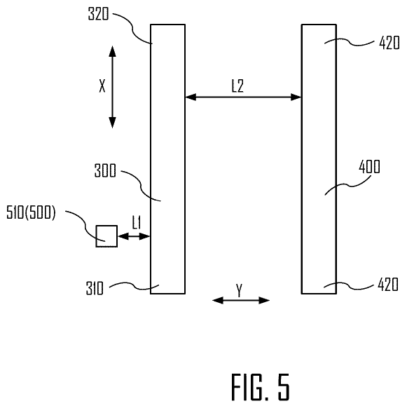

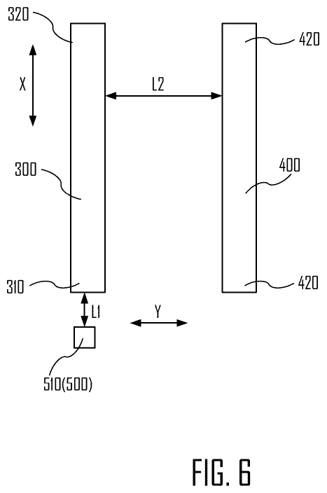

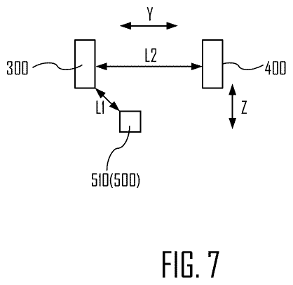

Taking the positional relationship between the first temperature-sensing element 510 and the first power pin 300 as an example for description, referring to FIG. 4, the first temperature-sensing element 510 may be located between the first power pin 300 and the second power pin 400 in the spacing direction Y. In another possible embodiment, referring to FIG. 5, the first power pin 300 may be located between the first temperature-sensing element 510 and the second power pin 400 in the spacing direction Y. In some other possible embodiments, such as those depicted in FIG. 6, the first temperature-sensing element 510 may be located at a side of the first end 310 of the first power pin 300 away from the second end 320 in the extension direction X. Referring to FIG. 7, in some other possible embodiments, the first temperature-sensing element 510 may be located on the same side of the first power pin 300 and the second power pin 400 in the lateral direction Z.

The positional relationship between the second temperature-sensing element 520 and the second power pin 400 may be described with reference to the positional relationship between the first temperature-sensing element 510 and the first power pin 300.

In other embodiments, the temperature-sensing element 500 may be arranged in other manners.

For example, the two-pin temperature control plug 100 shown in FIGS. 8 and 9 only may include the first power pin 300 and the second power pin 400. In addition, only one temperature-sensing element 500 may be provided in the accommodating cavity 210, and the temperature-sensing element 500 may be configured to measure the temperature of the first power pin 300. In some other possible embodiments, a plurality of, such as two, three or four, temperature-sensing elements 500 may be provided in the accommodating cavity 210.

For example, still referring to FIGS. 8 and 9, in the embodiments of the present disclosure, the temperature-sensing element 500 may be fixed in the accommodating cavity 210 by means of one thermally conductive terminal 700. In the embodiments of the present disclosure, the thermally conductive terminal 700 may be made of copper, but may not be limited thereto. For example, in some other possible embodiments, the thermally conductive terminal 700 may also be made of a material, such as aluminum, having good thermal and electrical conductivity.

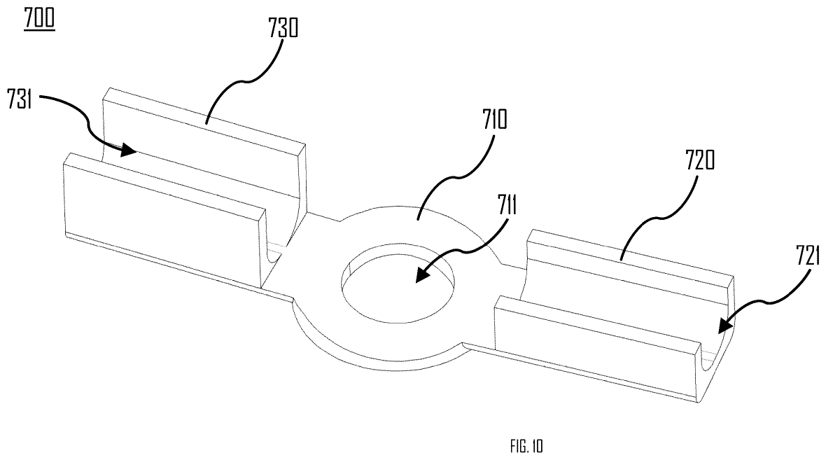

Referring to FIG. 10 in combination with FIGS. 8 and 9, the thermally conductive terminal 700 may include a pin connection portion 710, a first connecting portion 720, and a second connecting portion 730. The pin connection portion 710 may be located between the first connecting portion 720 and the second connecting portion 730. The pin connection portion 710 may be electrically connected to the first end 310 of the first power pin 300. The temperature-sensing element 500 may be connected to the first connecting portion 720, such that the temperature-sensing element 500 measures the temperature of the first power pin 300 by means of the thermally conductive terminal 700. One end of the first power cord 120 may be electrically connected to the second connecting portion 730, and may be thus electrically connected to the first power pin 300 by means of the thermally conductive terminal 700, such that the first power pin 300 supplies power to the external load by means of the first power cord 120.

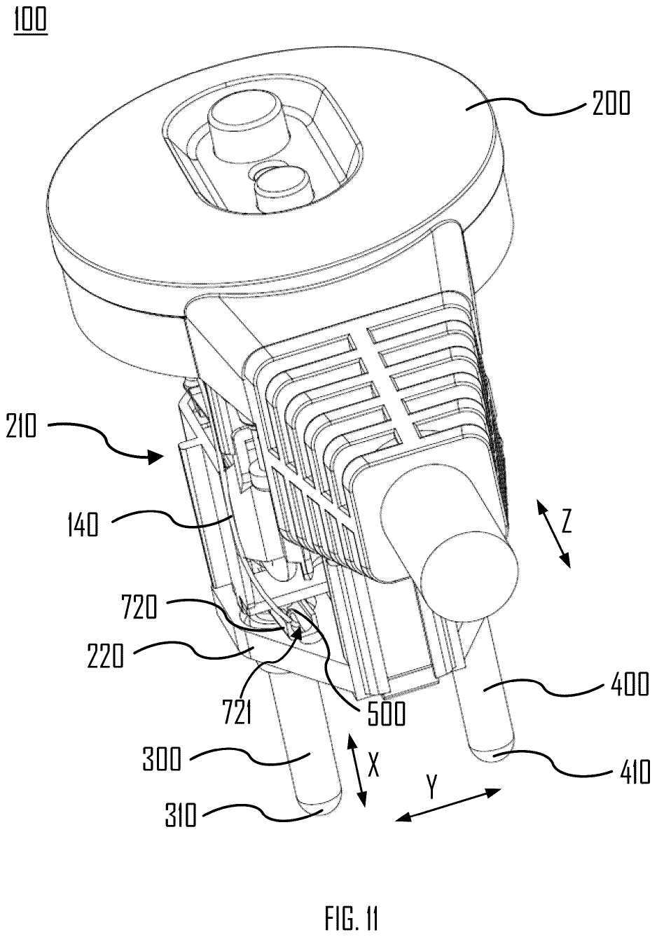

Specifically, referring to FIGS. 8 to 11, the pin connection portion 710 may have a connecting hole 711, and the first end 310 of the first power pin 300 may pass through the connecting hole 711 and may then be fixed to the connecting hole 711 by means of, for example, welding, or any other similar fixed coupling method. The first connecting portion 720 and the second connecting portion 730 respectively may extend outwardly from two sides of the pin connection portion 710 and may form a first groove 721 and a second groove 731. The temperature-sensing element 500 may be accommodated in the first groove 721 and fixed in the first groove 721 by means of a thermally conductive insulation material (e.g., thermally conductive silicone, thermally conductive gel, or a thermally conductive epoxy adhesive). For example, the temperature-sensing element 500 may be electrically connected to the control circuit board 110 by means of a wire 140.

In this way, when the temperature of the first power pin 300 rises during the operation of the temperature control plug 100, since the thermally conductive terminal 700 may be physically connected to the first power pin 300, the temperature of the first power pin 300 may be transferred to the thermally conductive terminal 700, and the temperature-sensing element 500 may measure the temperature of the thermally conductive terminal 700 and thus measure the temperature of the first power pin 300. When the temperature of the first power pin 300 reaches the preset temperature value, the temperature-sensing element 500 may generate feedback in the form of a temperature-sensing signal to the control circuit board 110, and the control circuit board 110 may receive the temperature-sensing signal and then control the circuit to be disconnected, so as to prevent the temperature control plug 100 and the socket from being burned out due to continuous temperature rise of the first power pin 300 and the second power pin 400 to avoid dangers.

In some embodiments, after electrical power is interrupted by the control circuit board 110 in response to the measured temperature reaching the preset temperature value, the control circuit board 110 may be configured to automatically restore electrical power when the measured temperature falls below a reset temperature value. In some other embodiments, the control circuit board 110 may maintain the circuit in a disconnected state until the temperature control plug 100 is unplugged from the socket or otherwise manually reset by a user. In yet other embodiments, the control circuit board 110 may be configured to require both a reduction in temperature and a manual reset action before restoring electrical power.

Furthermore, the control circuit board 110 may be configured to evaluate the measured temperature over a predetermined time interval before interrupting electrical power, such that transient temperature fluctuations or short-duration temperature spikes do not cause unintended power interruption. For example, the control circuit board 110 may be configured to interrupt electrical power only when the measured temperature exceeds the preset temperature value for a continuous duration exceeding a predetermined time threshold.

In addition, the second power pin 400 may also be provided with a thermally conductive terminal 700, and a temperature-sensing element 500 may be provided at the first connecting portion 720 of the thermally conductive terminal 700, so that the temperature-sensing element 500 measures the temperature of the second power pin 400 by means of the thermally conductive terminal 700; and one end of the second power cord 130 may be electrically connected to the second connecting portion 730, and may be then electrically connected to the second power pin 400 by means of the thermally conductive terminal 700, so that the second power pin 400 supplies power to the external load by means of the second power cord 130. The second power pin 400 may be connected to the thermally conductive terminal 700, the temperature-sensing element 500 and the second power cord 130 in the same manner as the connection of the first power pin 300 to the thermally conductive terminal 700, the temperature-sensing element 500 and the first power cord 120.

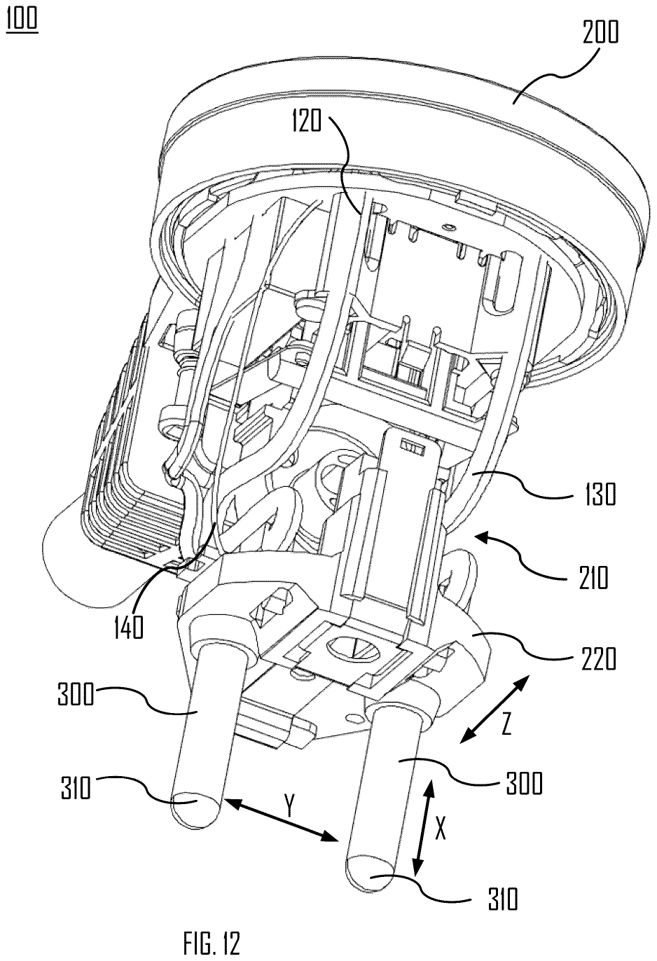

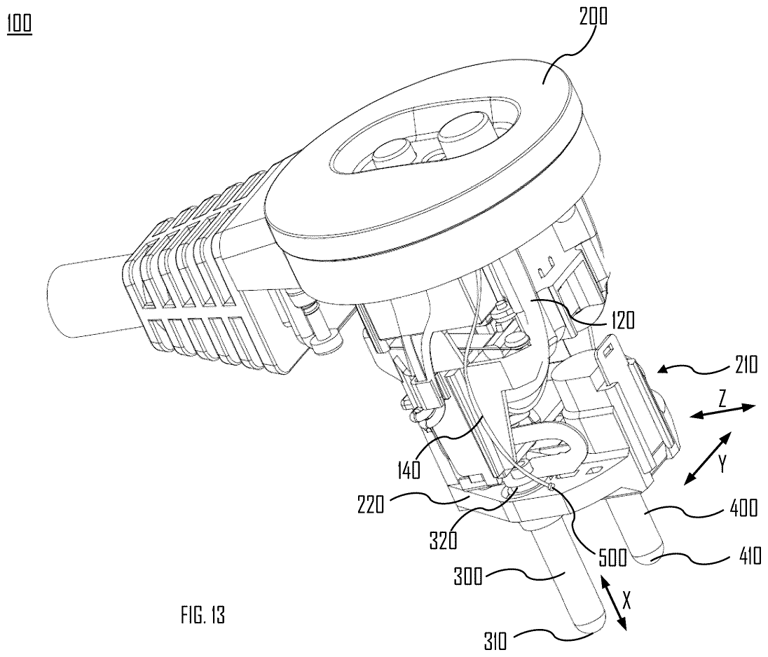

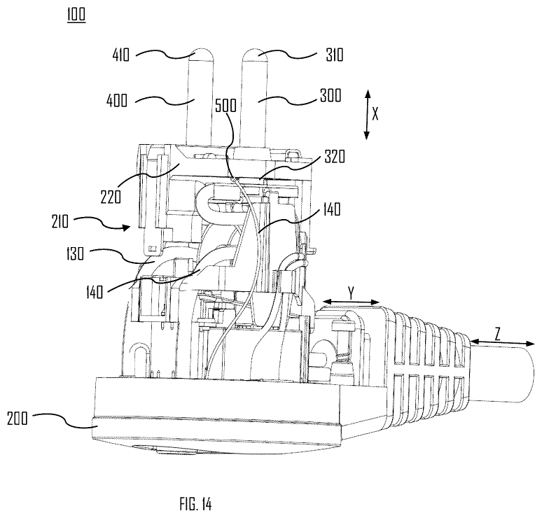

Referring to FIGS. 12 to 14, in another embodiment, the temperature-sensing element 500 may be arranged on an inner surface of the pin accommodation portion 220 of the housing 200 by means of, for example, bonding, clamping or welding, and the temperature-sensing element 500 may be electrically connected to the control circuit board 110 by means of a wire 140.

For example, the temperature-sensing element 500 may be arranged closer to the first power pin 300 than the control circuit board 110, and the ratio of the first distance L1 (i.e., the distance between the temperature-sensing element 500 and the first power pin 300) to the second distance L2 (i.e., the distance between the first power pin 300 and the second power pin 400) may be less than or equal to 0.3 (e.g., the ratio of the first distance L1 to the second distance L2 may also be 0.28, 0.25, 0.2, 0.1, etc.), which improves the measurement accuracy of the temperature-sensing element 500 for the temperature of the first power pin 300.

In this way, during the operation of the temperature control plug 100, when the temperature of the first power pin 300 measured by the temperature-sensing element 500 reaches the preset temperature value, the temperature-sensing element 500 feeds back a temperature-sensing signal to the control circuit board 110, and the control circuit board 110 receives the temperature-sensing signal and then controls the circuit to be disconnected, so as to prevent the temperature control plug 100 and the socket from being burned out due to continuous temperature rise of the first power pin 300 and the second power pin 400 to avoid dangers.

In some embodiments, the control circuit board 110 may be further configured such that a failure of the temperature-sensing element 500, a failure of communication between the temperature-sensing element 500 and the control circuit board 110, or an abnormal operating condition of the control circuit board 110 results in interruption of electrical power supplied through the temperature control plug 100. In this manner, the temperature control plug 100 may operate in a fail-safe mode to further reduce the risk of overheating or electrical hazards.

It should be noted that the specific position of the temperature-sensing element 500 on the inner surface of the housing 200 may not be specifically limited in the embodiments of the present disclosure, as long as the ratio of L1 to L2 may be less than or equal to 0.3.

Furthermore, it should be noted that, in each of the embodiments described herein, the temperature control plug 100 may be configured for use with alternating current (AC) power, direct current (DC) power, or combinations thereof, and may be adapted for use with different voltage levels, current ratings, and electrical standards without departing from the scope of the present disclosure.

To this end, the present disclosure satisfactorily discloses a solution for measuring the temperature of the first power pin by means of the temperature-sensing element, so that when the temperature of the first power pin reaches the preset temperature value, the temperature-sensing element can feed back the temperature-sensing signal to the control circuit board to control the circuit to be disconnected, which can prevent the plug or the socket from being burned out due to continuous temperature rise of the first power pin.

The foregoing descriptions are only embodiments of the present disclosure and are not intended to limit the present disclosure. For those skilled in the art, various changes and variations can be made to the present disclosure. Any modifications, equivalent replacements, and improvements made without departing from the spirit and principle of the present disclosure shall fall within the scope of the claims of the present disclosure.

Furthermore, it should be apparent that the present disclosure is not limited to the details of the above-mentioned exemplary embodiments, and the present disclosure can be implemented in other specific forms without departing from the spirit or basic features of the present disclosure. Therefore, no matter from which point of view, the embodiments should all be regarded as exemplary and non-limiting. The scope of the present disclosure is defined by the appended claims rather than the above-mentioned description, and therefore it is intended that all changes which fall within the meaning and range of equivalents of the claims are embraced in the present disclosure. Any reference signs in the claims should not be construed as limiting the claims involved. In addition, it is apparent that the word “comprise/include” does not exclude other elements or steps, and the singular does not exclude the plural. The terms first, second, etc. are used for designations and do not represent any particular order.

It should be understood that the embodiments as shown in the drawings only show the optional shapes, sizes and arrangements of optional components of the temperature control plug according to the present disclosure, which are merely illustrative but not restrictive, and other shapes, sizes and arrangements may be employed without departing from the idea and scope of the present disclosure.

The technical contents and technical features of the present disclosure are disclosed above, but it can be understood that those skilled in the art would have made various variations and improvements to the concepts disclosed above under the creative idea of the present disclosure, and all the variations and improvements fall into the scope of protection of the present disclosure. The descriptions of the above embodiments are illustrative but not restrictive, and the scope of protection of the present disclosure is determined by the claims.

1. A temperature control plug comprising:
a housing having an accommodating cavity;
a first power cord and a second power cord, each of the first power cord and the second power cord being configured to supply power to an external load;
a first power pin connected to the first power cord, the first power pin comprising a first end and a second end, the first end of the first power pin being located in the accommodating cavity, and the second end of the first power pin extending out of the accommodating cavity;
a second power pin connected to the second power cord, the second power pin comprising a first end and a second end, the first end of the second power pin being located in the accommodating cavity, the second end of the second power pin extending out of the accommodating cavity, and the second power pin being spaced apart from the first power pin;
a control circuit board; and
a temperature-sensing element arranged in the accommodating cavity and electrically connected to the control circuit board, the temperature-sensing element being configured to measure a temperature of the first power pin.

2. The temperature control plug according to claim 1, wherein the temperature-sensing element is arranged closer to the first power pin than the control circuit board.

3. The temperature control plug according to claim 1, wherein a distance between the temperature-sensing element and the first power pin is a first distance, a distance between the first power pin and the second power pin is a second distance, and a ratio of the first distance to the second distance is less than or equal to 0.3.

4. The temperature control plug according to claim 3, wherein the temperature-sensing element is located between the first power pin and the second power pin.

5. The temperature control plug according to claim 3, wherein the first power pin is located between the temperature-sensing element and the second power pin.

6. The temperature control plug according to claim 1, wherein the temperature control plug further comprises:
a temperature-sensing circuit board arranged in the accommodating cavity and electrically connected to the control circuit board, the temperature-sensing circuit board being further located between the first power pin and the second power pin and arranged on the temperature-sensing circuit board.

7. The temperature control plug according to claim 6, wherein the temperature-sensing element comprises a first temperature-sensing element and a second temperature-sensing element; and
the first temperature-sensing element is located between the first power pin and the second temperature-sensing element, and the second temperature-sensing element is located between the first temperature-sensing element and the second power pin.

8. The temperature control plug according to claim 1, wherein the temperature-sensing element is arranged in the accommodating cavity; and
the temperature control plug further comprises a thermally conductive terminal to which the temperature-sensing element is fixed;
wherein the thermally conductive terminal comprises a pin connection portion fixed to the first power pin.

9. The temperature control plug according to claim 8, wherein the thermally conductive terminal is made of copper or aluminum.

10. The temperature control plug according to claim 8, wherein the temperature-sensing element is fixed to the thermally conductive terminal by means of a thermally conductive insulation material.

11. The temperature control plug according claim 1, wherein the temperature-sensing element is arranged on an inner surface of the housing, and a ratio of a distance between the temperature-sensing element and the first power pin to a distance between the second power pin and the first power pin is less than or equal to 0.3.

12. A temperature control plug, comprising:
a housing configured to interface with a power socket;
a plurality of conductive power pins arranged to conduct electrical power between the power socket and an external electrical load;
at least one temperature-sensing element positioned within the housing proximate to at least one of the conductive power pins; and
a control circuit operatively coupled to the temperature-sensing element and the conductive power pins,
wherein the control circuit is configured to interrupt electrical power delivered through the plug when a temperature measured by the temperature-sensing element satisfies a predetermined temperature condition associated with overheating of at least one of the plurality of conductive power pins.

13. The temperature control plug interface of claim 12, wherein the temperature-sensing element is positioned closer to the control circuit than the plurality of conductive power pins than.

14. The temperature control plug interface of claim 12, wherein the temperature-sensing element is positioned closer to the plurality of conductive power pins than the control circuit.

15. The temperature control plug of claim 12, wherein a distance between the temperature-sensing element and at least one of the plurality of conductive power pins is less than or equal to 0.3 times a distance between adjacent conductive power pins.

16. The temperature control plug of claim 12, wherein the temperature-sensing element is mounted on a temperature-sensing circuit board distinct from a control circuit board.

17. The temperature control plug of claim 12, further comprising a thermally conductive pin physically coupled to at least one of the plurality of conductive power pins, the temperature-sensing element being thermally coupled to the thermally conductive pin.

18. The temperature control plug of claim 17, wherein the thermally conductive pin is formed from copper or aluminium.

19. The temperature control plug of claim 12, wherein the temperature-sensing element comprises a plurality of temperature-sensing elements configured to monitor the plurality of conductive power pins.

20. A method of preventing overheating of an electrical plug, comprising:
supplying electrical power to an external load through a plug having at least one conductive power pin;
measuring a temperature associated with the conductive power pin using a temperature-sensing element positioned within the plug proximate to the conductive power pin;
transmitting a temperature signal corresponding to the measured temperature to a control circuit within the plug; and
automatically interrupting electrical power supplied through the plug when the measured temperature reaches or exceeds a predetermined temperature threshold.
